(19) United States
(12) Patent Application Publication
(10) Pub. No.: US 2013/0226980 A1
(43) Pub. Date: Aug. 29, 2013

(54) MULTIPURPOSE CALCULATION COMPUTING DEVICE

(71) Applicants: Laura Grigori, Paris (FR); Frederic Nataf, Paris (FR)

(72) Inventors: Laura Grigori, Paris (FR); Frederic Nataf, Paris (FR)

(73) Assignees: INRIA INSTITUT NATIONAL DE RECHERCHE EN INFORMATIQUE ET EN AUTOMATIQUE, Le Chesnay (FR); UNIVERSITE PIERRE ET MARIE CURIE (PARIS 6), Paris (FR); CENTRE NATIONAL DE LA RECHERCHE SCIENTIFIQUE (C.N.R.S.), Paris (FR)

(21) Appl. No.: 13/813,837

(22) PCT Filed: Aug. 2, 2011
(86) PCT No.: PCT/FR2011/051859

§ 371 Date: May 8, 2013

(30) Foreign Application Priority Data
Aug. 3, 2010 (FR) 10 03248

(51) Int. Cl. G06F 17/16

(52) U.S. Cl. CPC G06F 17/16
USPC 708/446

(57) ABSTRACT

A calculation computer includes a calculator-solver receiving a working matrix representation corresponding to a system of equations, as well as residue data, and for providing a solution to the system of equations from residue data, an adapter receiving an initial matrix representation corresponding to a system of equations to be processed, as well as a filtering matrix representation, the working matrix representation forced to meet with the initial matrix representation, the adapter iteratively calculates blockwise an intermediate matrix from the initial matrix representation and from said numerical representation of a filtering matrix representation, the calculator-solver works on this intermediate matrix, blockwise, so as to provide a solution of the system of equations of the initial matrix representation, without completely inverting the latter,

### CROSS-REFERENCE TO RELATED APPLICATIONS

This application claims priority to International Application No. PCT/FR2011/051859 (“PCT '859”) filed Aug. 2, 2011 and published as WO 2012/017177 on Feb. 9, 2012. PCT '859 claims priority to French Application No. 10 03248 filed Aug. 3, 2010. All of the above applications are incorporated herein by reference.

### FIELD OF INVENTION

The invention relates to the modeling and simulation of complex physical systems.

### BACKGROUND

In many fields of modern physics, the equations which govern a physical phenomenon cannot be solved theoretically. This is notably the case of all the problems which relate to fluid mechanics, for example in the modeling of the operation of an oil field.

In these situations, the differential equations are solved numerically, i.e. by discretizing the general equations, according to particular parameters of the simulation.

These discrete systems are solved by using matrices of very large size, in which the discretized equations form the bases of the systems. These base matrices are difficult to invert.

In order to solve this problem, iterative methods are widely used today. These methods, for example the one called “GMRES”, are based on Krylov sub-spaces. With the purpose of accelerating convergence of the iterative methods, “pre-conditioners” have been created. These are elements which calculate a matrix close to the base matrix, and the inverse of which may be effectively applied to an arbitrary vector.

Pre-conditioners are of interest, but pose problems with certain vectors for which they do not reliably reproduce the base matrix. In order to solve this problem, pre-conditioners “fulfilling a filtering property” have been developed, which have the particularity of being an accurate picture of the base matrix for a particular selected vector.

To this day, the methods for producing pre-conditioners satisfying a filtering condition require base matrices having a very specific form, which strongly limits the use and the utility of the pre-conditioners fulfilling a filtering property. The invention can improve the situation.

### SUMMARY

For this purpose, the present invention proposes a versatile calculation computer device of the type including calculator-solver, laid out in order to receive a working matrix representation and an initial matrix representation corresponding to a system of equations, as well as data of residues, and for providing a solution of the system of equations from the data of residues, an adapter, laid out for receiving an initial matrix representation corresponding to a system of equations to be processed, as well as a filtering matrix representation forming a filtering matrix representation for this system of equations, and laid out for calculating a working matrix representation corresponding to a system of equations which may be solved by the calculator-solver, and the working matrix representation being forced to meet with the initial matrix representation, a stability condition comprising an expression for comparing two matrix products both including said filtering matrix representation or its transposed and respectively including the initial matrix representation and the working matrix representation.

The adapter is laid out for iteratively calculating blockwise an intermediate matrix from the initial matrix representation and from said filtering matrix representation, while the calculator-solver is laid out so as to work on this intermediate matrix, blockwise, so as to provide a solution of the system of equations of the initial matrix representation, without complete inversion of the latter, while said iterative calculation of the adapter follows a calculation rule wherein a current block (i, j) of the intermediate matrix is defined by the difference between the corresponding block (i, j) of the initial matrix representation and a sum of blocks each defined by a product involving two already calculated blocks of the intermediate matrix, and an auxiliary block of an approach matrix which is forced to meet, with an already calculated diagonal block of the intermediate matrix, an equivalence condition, having an expression for comparing two matrix products both including said filtering matrix representation or its transposed and an already calculated block of the intermediate matrix, and respectively including the inverse of said already calculated diagonal block of the intermediate matrix, and said auxiliary block of the approach matrix.

Such a device is particularly advantageous, since it allows the application of a pre-conditioner meeting a filtering condition, and this regardless of the base matrix which defines the system, the solving of which is sought.

The invention also relates to a method including receiving an initial matrix representation corresponding to a system of equations to be processed and a filtering matrix representation, calculating a working matrix representation meeting with the initial matrix representation, a stability condition comprising an expression for comparing two matrix products both including said filtering matrix representation or its transposed, and respectively including the initial matrix representation and the working matrix representation, and receiving data of residues, and solving the system of equations defined by the initial matrix representation, from the data of residues, the working matrix representation and the initial matrix representation.

The operation of calculating a working matrix representation includes the iterative blockwise calculation of an intermediate matrix from the initial matrix representation and from said filtering matrix representation by iteratively repeating, for each block of current index (i, j) of the intermediate matrix calculating a sum of blocks each defined by a product involving two already calculated blocks of the intermediate matrix, and an auxiliary block of an approach matrix which is forced to meet with an already calculated diagonal block of the intermediate matrix, an equivalence condition, including an expression for comparing two matrix products both including said filtering matrix representation or its transposed and an already calculated block of the intermediate matrix, and respectively including the inverse of said already calculated diagonal block of the intermediate matrix and said auxiliary block of the approach matrix, calculating the difference between the block (i, j) of the matrix of the initial matrix representation and the sum from the operation above.

The operation of calculating the difference between the block of the matrix of the initial matrix representation and the sum from the operation includes an operation on the intermediate matrix, blockwise, so as to provide a solution of the system of equations of the initial matrix representation, without complete inversion of the latter.

### BRIEF DESCRIPTION OF THE DRAWINGS

Other features and advantages of the invention will become better apparent upon reading the description which follows, drawn from examples given as an illustration and not as a limitation, drawn from drawings wherein:

FIG. 1 represents a schematic view of a modeling and simulation system according to the invention,

FIG. 2 illustrates a simplified flow diagram of a modeling and simulation operation by means of the system of FIG. 1,

FIG. 3 illustrates a simplified flow diagram of an operation of FIG. 2,

FIG. 4 illustrates an example of a calculation function of a pre-conditioner according to an operation of FIG. 3,

FIG. 5 illustrates an example of a matrix obtained after a first re-ordering operation according to an optional operation of FIG. 3,

FIG. 6 illustrates an exemplary matrix obtained after a second re-ordering operation according to an optional operation of FIG. 3, and

FIG. 7 illustrates an exemplary modification of the function of FIG. 4 for setting into place parallelization of the calculations from a re-ordered matrix of the type of the one illustrated in FIGS. 5 and 6.

### DETAILED DESCRIPTION

The drawings and the description hereafter essentially contain elements with certainty. They may therefore not only be used for better understanding the present invention, but also for contributing to its definition, if necessary.

Further, the detailed description is expanded with Annex A, which gives the formulation of certain mathematical formulae applied within the scope of the invention. This annex is set apart with a purpose of clarification, and for convenience of references. It is an integral portion of the description, and may therefore not only be used for better understanding the present invention but also for contributing to its definition, if necessary.

Modeling and simulation of physical systems have become major issues. For example, in the operation of a hydrocarbon well, there is a first phase during which the oil flows out naturally. Next, gradually as the pressure decreases, it becomes necessary to act in order to recover the oil.

For this, it is possible for example to use a flow of water, which is introduced into the well in order to cause the pressure to increase again and cause a splashing up of the oil. But these hazardous operations require intimate knowledge of the well and of the reactions of the latter under these circumstances.

The equations which determine this physical problem are very complex, and for most of them only assume solutions by discretization and a numerical method of the finite difference or finite volume type.

The thereby discretized problems may then be summarized in formula (10) of Annex A, wherein A is the base matrix which defines the discretized system of equations, X is the vector which is sought and Y is the known result vector.

This type of problem is well known in algebra, and the question is to find the inverse matrix of A in order to calculate X. But inversion of matrices is a complex problem, which monopolizes computing powers which increase exponentially with the size of the matrix to be inverted.

For this, iterative methods based on Krylov sub-spaces, like GMRES, are widely used today. In order to accelerate the convergence of these methods, “pre-conditioners” have been proposed. Pre-conditioners are matrices which give the possibility of rapidly approaching the inverse matrix of A. By using the pre-conditioner M, the iterative method solves the linear system

M-1 A x=M-1 b.

In this solving method, operations of the type M-1 V and A V wherein V is a vector, are calculated, without explicitly calculating the inverse of M.

As this was explained above, there exists a particular class of pre-conditioners, pre-conditioners which satisfy a filtering property.

Pre-conditioners satisfying a filtering property have the additional advantage of behaving in the same way as the matrix A for a given vector, as this is explained in formula (20) of Annex A, wherein M is the pre-conditioner, and t the selected vector.

To this day, only matrices A which are tridiagonal blockwise are used for producing a pre-conditioner satisfying a filtering property. This considerably restricts their field of application.

Further, the methods for calculating these pre-conditioners are mostly sequential methods, which makes them rapidly prohibitory in terms of computing costs, and are therefore not very used in practice. Indeed, only matrices from a structured meshing may be processed in parallel, which considerably restricts their field of application.

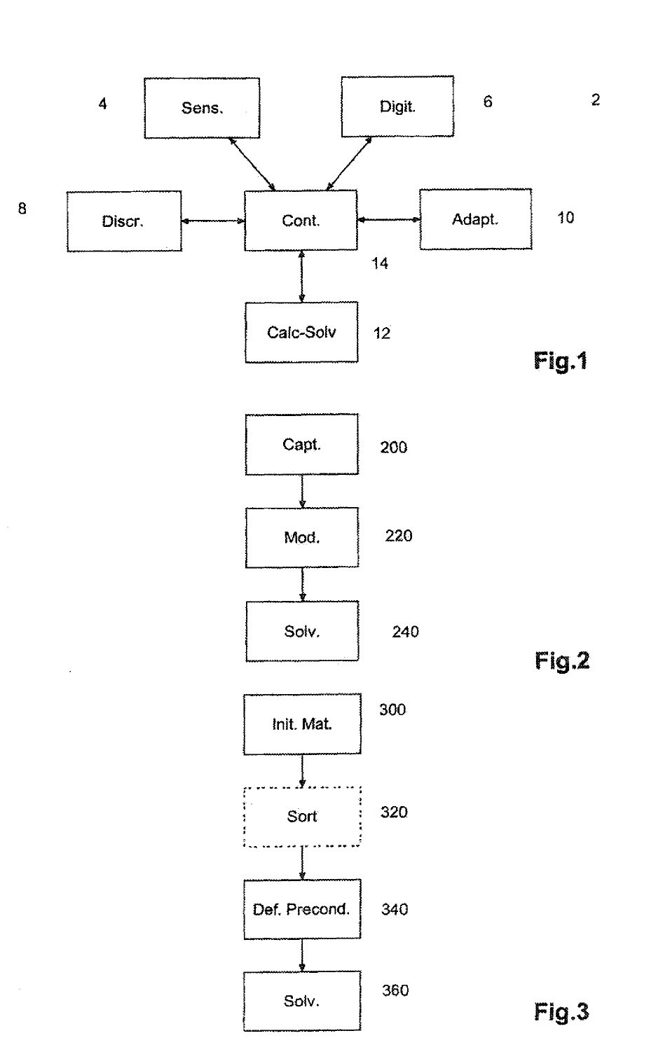

FIG. 1 represents a versatile calculation computer device 2 according to the invention. The device 2 comprises a set of sensors 4, a digitizer 6, a discretizer 8, an adapter 10, a calculator-solver 12, and a driver 14 which controls them.

In the example described herein, the set of sensors 4 are used for obtaining the data which constrain the physical system to be modeled, and the digitizer 6 is used for transforming these analog data in order to inject them into theoretical equations.

These elements are, so to speak, unconcerned about the problems solved by the invention: they are used for defining the framework for its practical application. Thus, also, their making may be very diverse.

The discretizer 8 is called by the driver 14 in order to discretize the theoretical equations made distinct with actual data, and for drawing therefrom a system of linear equations.

This system generally has a very large size, and its lines form the matrix A. There again, this element may be achieved in many different ways.

Finally, the adapter 10 and the calculator 12 are called by the driver 14 for calculating the pre-conditioner and for drawing up a solution corresponding to a particular situation for which modeling is sought. In this case, the data on the “right side” of the equation involving the matrix A are also called residue data, with reference to Newton methods.

The driver 14 may call the adapter 10 and the calculator 12 for having this particular solution develop per successive time steps and thus giving a simulation of the evolution of the modeled physical system.

According to another example, the adapter 10 is called only once by the driver 14 for calculating a pre-conditioner which is used for the whole period of the simulation, and the result calculated by the calculator 12 for a given time step is used as an input for the next time step.

According to a further example, the adapter 10 may be selectively called by the driver 14, depending on the development of the simulation, notably if the latter tends to modify the original system of the matrix A.

Here again, the simulation techniques are diverse.

FIG. 2 shows a simplified flow diagram showing the operations summarized above: In an operation 200, the set of sensors 4 is called in order to measure all the parameters required for the simulation, In an operation 220, the digitizer 6 and the discretizer 8 are called for modeling the system numerically, with the measurements drawn from the operation 200, In an operation 240, the adapter 10 and the calculator 12 are called in order to carry out the simulation as such.

FIG. 3 shows a simplified flow diagram of the operation 240. In an operation 300, the driver 14 transmits the matrix A drawn from the operation 220 to the adapter 10. In an optional operation 320, the adapter 10 re-orders the elements of the matrix A in order to allow subsequent processing in parallel. This operation may be carried out in several ways, for example, by nested dissection or by partitioning into several independent domains which may also overlap and have a recursive sub-partition.

Such overlapping slightly increases the computing costs but provides better convergence rates and superior robustness as this is achieved in the Schwartz method. The adapter 10 thus gives the possibility of obtaining a re-ordered matrix B which comprises blocks of zeros.

Next, in operation 340, the adapter 10 processes the matrix A, either re-ordered or not, in order to draw therefrom a representation of a pre-conditioner M satisfying a filtering property. Finally, in operation 360, the driver 14 calls the calculator 12 with the representation of the pre-conditioner M in order to achieve the simulation.

The device formed by the adapter 10, the calculator 12, and the driver 14, therefore allows:

Calculation of a representation of a pre-conditioner verifying a filtering property for any matrix A as an input, and

Massive parallelization of the calculations related to the pre-conditioner when the adapter 10 is called for re-ordering the matrix A.

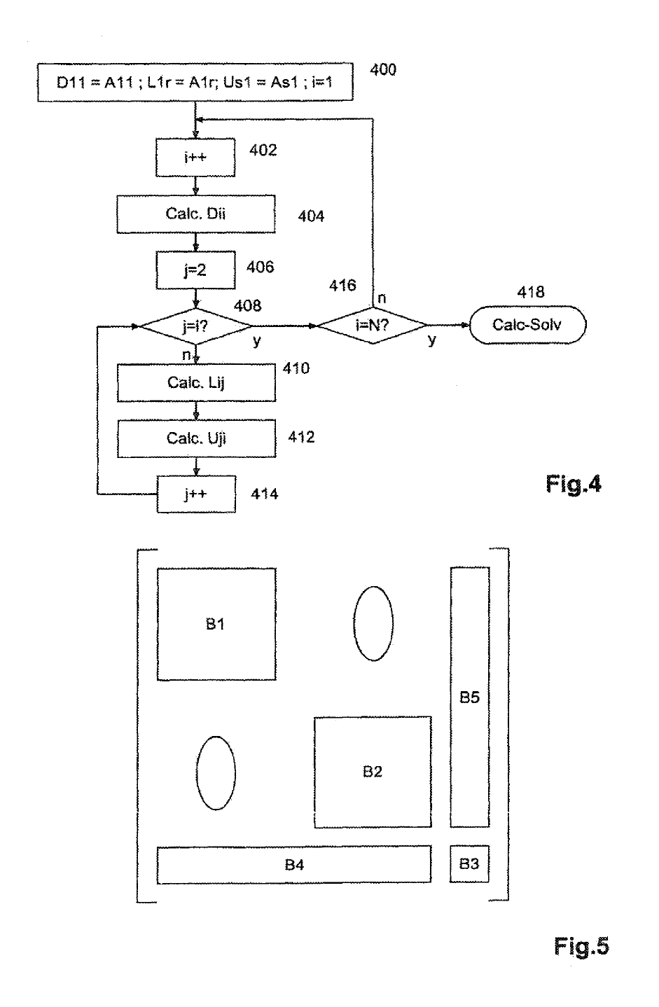

FIG. 4 represents a flow diagram for calculating the pre-conditioner according to the invention.

This calculation is based on the decomposition of a pre-conditioner M in the form of formula (30) of the Annex A. This decomposition into an LDU matrix is in principle known but the calculation of the elements is different. The formulae (40), (50) and (60) of Annex A give the composition of these respective elements.

The decomposition of the pre-conditioner in the LDU form is very advantageous, since it gives the possibility of solving the actual system without having to invert the matrix M. More specifically, the technique contains many algorithms which allow simplified resolution of a matrix equation when the LDU decomposition is used.

For this reason, the calculation of the pre-conditioner M as such is never achieved and only its LDU components are calculated and stored. Next, the calculator-solver 12 calls them selectively in order to solve the system.

It would nevertheless be possible to calculate the pre-conditioner M, by applying formula (30).

In order to calculate the elements of the LDU decomposition, the applicants have discovered a formulation based on the calculation of a matrix C which corresponds to the sum of the L, D and U matrices (formula 70 of Annex A).

Because of the respective form of the matrices L, D and U, it appears that each element of the matrix C corresponds to a single element of each of the matrices L, D, U. Thus:

Dᵢᵢ=Cᵢᵢ, and Dᵢⱼ=0 for i different from j,

Lᵢⱼ=q for i>1 and i strictly greater than j, and Iᵢⱼ=0 for i less than or equal to j,

Uᵢⱼ=q for j>1 and j strictly greater than i, and Uᵢⱼ=0 for j less than or equal to i.

The applicants have discovered that the matrix C may be established according to formula (80) of Annex A, wherein the term Fₖⱼ satisfies formula (90) of Annex A.

In formula (80), the first line only represents initialization. Conceptually, this first line is equivalent to the second line. Indeed, for i=1 or j=1, then min (i, j)−1 has the value 0, which means that the sum of this second line does not comprise any term, and gives a result identical with that of the first line.

The formula (90) expresses the fact that the matrix F which groups the terms Fₖⱼ is a matrix which approaches the diagonal block Dₖₖ for the condition relating to the index j. Thus, the fact that Fₖⱼ satisfies formula (90) may be considered as an equivalence condition with the inverse of the diagonal block Dₖₖ for the condition relating to the index j.

When the vector Uₖⱼtⱼ does not have any zero component, calculation of Fₖⱼ is easy. However, in order to take into account cases when this vector has zero components, it is possible to modify the approaches of the literature according to formula (100) of Annex A.

The applicants have also discovered another calculation for the matrix C, in which, in formula (80) the term Fₖⱼ is replaced with the term Gₖⱼ which is defined with formula (110) of Annex A. In order to calculate the terms Gₖⱼ, the corresponding term Fₖⱼ is first calculated by means of formula (100), and then formula (110) is applied.

It is also possible to define the term Fₖⱼ satisfying the filtering condition (90) by formula (120) combined with formula (140) of Annex A, which is derived from deflation methods of linear algebra. In the case when the blocks Dₖₖ are symmetrical, it is possible to use formula (130) of Annex A, which is a simplified version of formula (120).

In the present state of research of the applicants, formula (100) is preferred to formula (110), for reasons of stability.

FIG. 4 represents an exemplary function with which it is possible to calculate the matrices L, D and U. For this, each term of the matrix is calculated, and allocated to the matrix L, D and U as appropriate.

Alternatively, the terms are not allocated to each matrix L, D, U but to matrix C alone, which is directly used by the calculator-solver 12. In fact, it was seen above that the matrix C is equivalent to the matrices L, D and U, and both of these alternatives only represent different ways for expressing the pre-conditioner M.

Considering the foregoing, the first element of the matrix D may be calculated directly, since it corresponds to the first term of the diagonal of matrix A (or B if operation 320 is performed).

Also, all the non-zero terms of the first column of the matrix L and the first line of the matrix U, respectively, are reset with the corresponding term of the matrix A. An index i is reset to 1. This is carried out in operation 400.

By first element or first term is meant a block. Indeed, the matrix A (or B if operation 320 is performed) is cut out into rectangular blocks, the sides of which are parameters which may be freely selected. Only the diagonal blocks of A have to be square.

The applicants use values of size such that the product of these values is equal to the size of the buffer memory, i.e. a given block of the matrix A may be stored in the buffer memory.

Alternatively, the applicants also use values of sides such that their product is less than the size of the buffer memory. If operation 320 is performed, the size of the blocks of matrix B is determined by this operation.

Next, a so-called global loop is performed which calculates all the other terms of the matrix C, and therefore all the terms of the matrices L, D and U, which allows definition of the pre-conditioner M.

The global loop in each iteration consists of first calculating the diagonal term, and then calculating by means of a local loop, the other terms, with increasing line and column index.

First, the index i of the global loop is incremented in an operation 402, and then in an operation 404, the diagonal term Dᵢᵢ is calculated according to formula (80).

The term Dᵢᵢ, as this was seen previously, corresponds to the term Cᵢᵢ. The operation 404 includes the calculation of the matrix F so as to satisfy formula (90), according to formula (100). If the second calculation method is retained, the calculation of G is also carried out according to Formula (110).

Next, the index j of the local loop is reset to two in an operation 406. This is followed by an operation 408 of the end of the local loop in which it is tested whether j is equal to i. When i has the value 2, this gives the possibility of directly passing to the following global loop iteration, as C₁₂ and C₂₁ are known.

The local loop is then performed, with the calculations of Lᵢⱼ which corresponds to Cᵢⱼ in an operation 410, and of Uⱼᵢ which corresponds to Cᵢⱼ in an operation 412.

It should be noted that the operations 410, 412 may be carried out in parallel, which is advantageous. Indeed, because of formula (80), the calculation of the terms Cᵢⱼ and Cⱼᵢ is independent.

Next, the index of the local loop j is incremented in an operation 414, and the local loop resumes with the test of the operation 408. When the local loop is finished, i.e. when all the terms of the line of L and all of the terms of the column of U have been calculated, a test checks in an operation 416 whether i is equal to the number of blocks N of the matrix M.

If this is the case, then the global loop is finished, and the operation ends in an operation 418, the call to the calculator-solver (12). Otherwise, the global loop resumes with incrementation of the index i of the global loop in operation 402.

As mentioned above, the function of FIG. 4 gives the possibility of obtaining a decomposition of M into the LDU form, which is used as a basis for known solving methods in algebra. Thus, the pre-conditioner M is not explicitly calculated. However, it can be possible to explicitly calculate the pre-conditioner, by applying formula (30).

The applicants have developed a device applying a pre-conditioner and a method for calculating a representation of this pre-conditioner which are particularly suitable for parallelization of the calculations.

In order to better understand this, an exemplary embodiment of the operation 320 should be explained in more detail. This example is here based on the case of a two-level nested dissection.

In this type of operation, the matrix A is modified so as to give it the form of a matrix B with the shape of an “arrow”. For this, the matrix A is “re-ordered” a first time in order to give it the form of the matrix illustrated in FIG. 5, and then the sub-matrices of the matrix of FIG. 5 are themselves re-ordered in the same way.

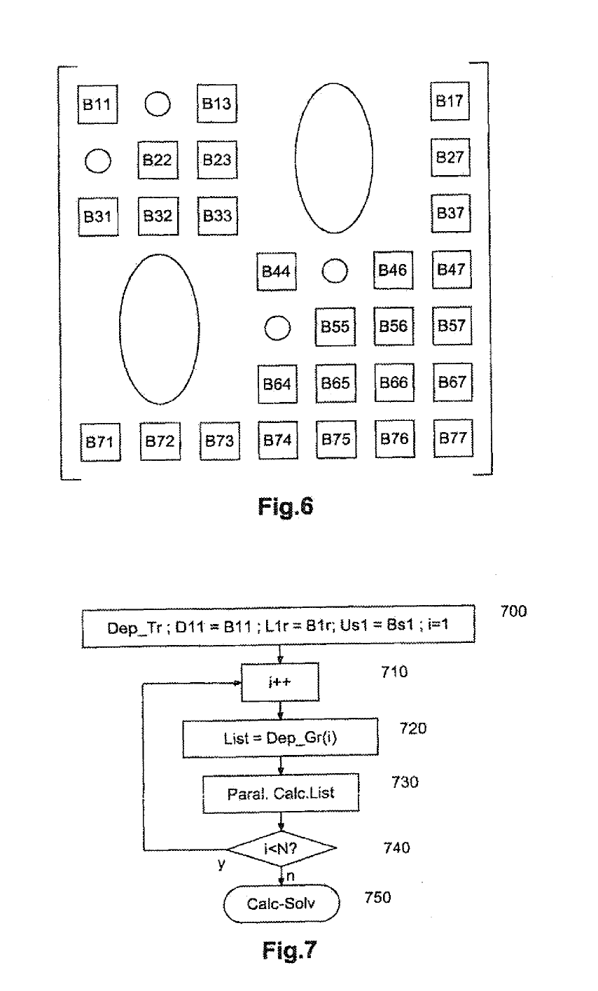

The matrix of FIG. 5 includes three diagonal blocks B1, B2 and B3, two blocks B4 and B5 respectively along the low and right edges of the matrix B and is zero elsewhere. This re-ordering of the matrix A is possible because of its low density. The same re-ordering is carried out on the vector t. Once the matrix of FIG. 5 has been calculated, it is possible to reapply this same re-ordering to the blocks B1 and B2, which results in the matrix B of FIG. 6. It should be noted in this figure that the block B3 of FIG. 5 is the block B77 of FIG. 6 and that the blocks B4 and B5 of FIG. 5 respectively correspond to the blocks B71 to B76 and to the blocks B17 to B67 of FIG. 6.

If formula (8) of the Annex A is analyzed, it appears by the first line of this formula that the blocks C11 to C17 and C21 to C71 are directly known from B. It also appears that in applying the second line of this formula, many blocks are zero or known, which makes possible the calculation of certain blocks Cᵢⱼ in an independent way of each other, and therefore their calculation may be performed in parallel.

Thus for B11, B22, B44 and B55, if these blocks are calculated in parallel, the same situation is repeated, and new blocks B33 and B66 may in turn be calculated in parallel, and so forth.

Generally, the applicants have therefore discovered that the operation 320 may be used for producing a matrix B equivalent to the matrix A, and which includes separate domains.

From these domains, it is possible to generate a task dependence graph, in which for a given level, all the nodes represent blocks which may be calculated in parallel for applying formula (80) of Annex A.

Once all the blocks related to the nodes of a given level are calculated, it becomes possible to calculate the blocks related to the nodes of the next level in the graph, there again in parallel. In order to calculate and order the task dependence graph, several techniques may be used, as this is known in graph theory.

The task dependence graph is calculated by covering the structure of the matrix B. The nodes of this graph represent tasks, i.e. calculations of blocks Cᵢⱼ of the formula (80) of Annex A.

The dependencies in this graph represent the order of the calculations imposed by formula (80) of Annex A. This graph may then be ordered by using static ordering or dynamic ordering of the tasks on the processors.

For example, dynamic ordering allocates during parallel execution the tasks which are ready to be executed on the available processors. Static ordering establishes in a first phase the order of the tasks to be executed on the different processing units in parallel with the purpose of minimizing the parallel computing time.

In a second phase, their execution occurs. A static distribution of the data may be used on processors of the sub-tree-to-sub-cube type or of the bi-dimensional type.

It is this observation which caused the modifications of the diagram of FIG. 4, which are shown with FIG. 7.

In this function, the first operation 700 corresponds to the operation 400 of FIG. 4. A difference with operation 400 is that operation 700 comprises the calculation of the task dependence graph as described above.

Next, the index i which corresponds to the level of the task dependence graph which is presently covered, is incremented in an operation 710.

Once the index i has been incremented, the driver 14 calls the adapter 10 in an operation 720 for recovering all the nodes of level i of the task dependence graph, by means of a function Dep_Gr( ).

The result of this function is sought in a list (List) which is a local variable which contains at each iteration the list of the pairs (k, l) which identify the independent blocks of the same level of the task dependence graph.

Next, the adapter calculates the blocks Cₖₗ for all the pairs of the list (List) in an operation 730. This calculation is executed in parallel, as all the blocks are independent with regard to formula (80) of Annex A, and are distributed on all the processors and the cores of the available processors.

It should be noted here that the calculation of the blocks by operation 730 is different from that of the operations 404, 410, 412. Indeed, if the formula used for the calculation is the same, the indices of the blocks are totally independent.

There where the function of FIG. 4 operates by first calculating the diagonal term, and then the terms of the line and of the corresponding column, here, it is the task dependence graph which determines which blocks are to be calculated.

It should be noted that in the present example, the nature of the matrix B generates some symmetry of the indices of each level in the task dependence graph.

However, the application of a method other than nested dissection may limit the symmetry, and the blocks may be calculated in an apparently arbitrary order.

Finally, in operation 740, the adapter 10 checks whether the index i is smaller than N, the number of levels of the graph. If this is the case, then the function resumes in 710 with incrementation of i for the next level of the task dependence graph. Otherwise, the function ends in operation 750 with calling to the calculator-solver 12, like with operation 418.

In the foregoing, the filtering condition is expressed by formula (20) of Annex A. This formula is a mathematical expression of the fact that the initial matrix A and the pre-conditioner M meet a stability condition which is based on the comparison of their product with a vector.

However, the stability condition should not be limited to the single formula (20). Thus, the applicants also successfully used formula (150) of Annex A.

As the formula (150) is almost the transposed of formula (20), the use of formula (150) as a stability condition does not change anything in the operating mode of the invention. Accordingly, the formulae (80) and (90) only have to be slightly modified, as shown with formulae (160) and (170). The formulae (100) and (140) may be adapted in a similar way.

Further, all the previous examples were carried out for a stability condition using a vector t.

However, when a physical system is modeled, many quantities are used. The experiments of the applicants show that it is advantageous to use a stability condition using a matrix, each column of which relates to a physical quantity.

Thus, if two physical quantities characterized a given modeling equation, it is advantageous to use as a filtering element t a matrix having two columns. In practice, this does not change the philosophy of the invention, and the calculations shown earlier are very slightly or not modified.

Indeed, in this type of situation, the equations represented in matrix A can be associated by square “miniblocks”, the side of which is equal to the number of columns of the matrix t. Thus, in the case described in the previous paragraph, each miniblock would be a square block with twice the two terms of the initial matrix A.

The reason for which these miniblocks are mentioned is that they should not be separated during the optional operation 320, and when the matrix A is cut into blocks. A given miniblock should always be contained in a single block of the matrix A or of the matrix B.

The only element which slightly changes is the calculation of a Fₖⱼ. Indeed, the formula (100) of Annex A is adapted to a matrix t with a single column, i.e. a vector, and the miniblocks are therefore of a 1×1 size, i.e. scalars.

The applicants have therefore generalized the formula (100) in the form of formula (180) wherein Diag( ) designates a function which generates a diagonal matrix, the elements of which are designated, are arguments of this function, and wherein the operation “/.” designates term-to-term division of the matrices. Thus A1/.A2 is a matrix A3, each term (i, j) of which is equal to the quotient of A1 (i, j) by A2 (i, j).

Another way of considering this modification is to note that the formula (100) may be considered as a particular case of formula (180), wherein t has a single column.

In the foregoing, the adapter 10, the computer 12 and the driver 14 may be made in different ways.

First of all, the driver 14 may be made in an integrated way with the adapter 10 and the computer 12, i.e. the latter are laid out in order to know how to interact, instead of being controlled separate elements which are not aware of each other.

Further, the presentation of the elements of the system 2 is mainly functional. Thus, these elements may be physically separated and connected through communication links or applied remotely in time, or further applied on a same piece of equipment with the driver 14 defined by the intrinsic links between these elements and a user interface.

Further, the discretizer 8, the adapter 10, the calculator 12 and the driver 14 may be applied in the form of analog elements, such as integrated circuits or daughterboards or in the form of numerical elements, i.e. in the form of programs applied by a computer, optionally in a remote and/or distributed way.

It should also be noted that in the foregoing, reference is often made equally to matrices or their representation. It is obvious that a computer does not know what a matrix is, and it is actually the numerical representation of these matrices, i.e. the data which define these matrices which are targeted. By matrix or by matrix representation, is therefore meant any structure of numerical data which allows processing of matrices within the scope of the invention.

Finally, the particular practical target of the device of the invention can be noted, which allows simulation and resolution of many physical problems which could not be solved earlier, for example in the oil industry.

### ANNEX A

$$\begin{matrix}Ax = y & ( 10 ) \\ At = Mt & ( 20 ) \\ [ \begin{matrix}{D}_{11} & & & \\ {L}_{21} & {D}_{22} & & \\ ⋮ & ⋱ & ⋱ & \\ {L}_{N 1} & ⋯ & {L}_{NN - 1} & {D}_{NN}\end{matrix} ] [ \begin{matrix}{D}_{11}^{- 1} & & & \\ & {D}_{22}^{- 1} & & \\ & & ⋱ & \\ & & & {D}_{NN}^{- 1}\end{matrix} ] [ \begin{matrix}{D}_{11} & {U}_{12} & ⋯ & {U}_{1 N} \\ & ⋱ & ⋱ & ⋮ \\ & & {N}_{N - 1 N - 1} & {U}_{N - 1 N} \\ & & & {D}_{NN}\end{matrix} ] & ( 30 ) \\ L = [ \begin{matrix}0 & & & \\ {L}_{21} & ⋱ & & \\ ⋮ & ⋱ & ⋱ & \\ {L}_{N1} & ⋯ & {L}_{NN - 1} & 0\end{matrix} ] & ( 40 ) \\ D = [ \begin{matrix}{D}_{11} & & & \\ & {D}_{22} & & \\ & & ⋱ & \\ & & & {D}_{NN}\end{matrix} ] & ( 50 ) \\ U = [ \begin{matrix}0 & {U}_{12} & ⋯ & {U}_{1 N} \\ & ⋱ & ⋱ & ⋮ \\ & & ⋱ & {U}_{N - 1 N} \\ & & & 0\end{matrix} ] & ( 60 ) \\ C = L + D + U & ( 70 ) \\ {C}_{ij} = \{ \begin{matrix}{A}_{ij} if i = 1 or j = 1 \\ {A}_{ij} - {\sum }_{k = 1 , {L}_{ik} \neq 0 , {U}_{kj} \neq 0}^{min ( i , j ) - 1} {L}_{ik} {F}_{kj} {U}_{kj} if i > 1 or j > 1\end{matrix} & ( 80 ) \\ {F}_{kj} {U}_{kj} {t}_{j} = {D}_{kk}^{- 1} {U}_{kj} {t}_{j} & ( 90 ) \\ {F}_{kj} ( r , s ) = \{ \begin{matrix}{D}_{kk}^{- 1} {U}_{kj} {t}_{j} ( r ) \text{/} {U}_{kj} {t}_{j} ( r ) if r = s and {U}_{kj} {t}_{j} ( r ) \neq 0 \\ {D}_{kk}^{- 1} {U}_{kj} {t}_{j} ( r ) \text{/} {U}_{kj} {t}_{j} ( s ) if {U}_{kj} {t}_{j} ( r ) = 0 with s such that \vert s - r \vert = {min}_{k \text{:} {U}_{kj} {t}_{j} ( k ) \neq 0} \vert k - r \vert \\ 0 otherwise\end{matrix} & ( 100 ) \\ {G}_{kj} = 2 {F}_{kj} - {F}_{kj} {D}_{kk} {F}_{kj} & ( 110 ) \\ Q = {{ZE}^{- 1} ( {D}_{kk} Z )}^{T} , E = {( {( {D}_{kk} Z )}^{T} {D}_{kk} Z )}^{- 1} , Z = {U}_{kj} {t}_{j} & ( 120 ) \\ Q = {ZE}^{- 1} {Z}^{T} , E = {( {Z}^{T} {D}_{kk} Z )}^{- 1} , Z = {U}_{kj} {t}_{j} & ( 130 ) \\ {F}_{kj} = P + Q , P = I - QA & ( 140 ) \\ {t}^{T} A = {t}^{T} M & ( 150 ) \\ {C}_{ij} = \{ \begin{matrix}{A}_{ij} if i = 1 or j = 1 \\ {A}_{ij} - {\sum }_{k = 1 , {L}_{ik} \neq 0 , {U}_{jk} \neq 0}^{min ( i , j ) - 1} {L}_{ik} {F}_{ik} {U}_{kj} if i > 1 or j > 1\end{matrix} & ( 160 ) \\ {t}_{i}^{T} {L}_{ik} {F}_{ik} = {t}_{i}^{T} {L}_{ik} {D}_{kk}^{- 1} & ( 170 ) \\ {F}_{kj} ( r , s ) = \{ \begin{matrix}Diag ( {D}_{kk}^{- 1} {U}_{kj} {t}_{j} ( r ) \text{/} . {U}_{jk} {t}_{j} ( r ) ) if r = s and {U}_{kj} {t}_{j} ( r ) has no zero component \\ Diag ( {D}_{kk}^{- 1} {U}_{kj} {t}_{j} ( r ) \text{/} . {U}_{kj} {t}_{j} ( s ) ) if {U}_{kj} {t}_{j} ( r ) = 0 with s such that \vert s - r \vert = {min}_{k \text{:} {U}_{kj} {t}_{j} ( k ) \neq 0} \vert k - r \vert \\ 0 otherwise\end{matrix} & ( 180 )\end{matrix}$$

1. A multipurpose calculation computer device of the type comprising:
a calculator-solver receiving a working matrix representation and an initial matrix representation corresponding to a system of equations, and receiving data of residues, and providing a solution of the system of equations from the data of residues,
an adapter receiving the initial matrix representation corresponding to a system of equations to process, as well as a filtering matrix representation for the system of equations, and calculating the working matrix representation corresponding to a system of equations which is solved by the calculator-solver,
wherein the working matrix representation is forced to meet with the initial matrix representation, a stability condition comprising a comparison of two matrix products both including said filtering matrix representation or its transpose, and respectively including the initial matrix representation and the working matrix representation,
wherein the adapter iteratively calculates blockwise an intermediate matrix from the initial matrix representation and from said numerical representation of a filtering matrix representation, while the calculator-solver is working on the intermediate matrix blockwise so as to provide a solution to the system of equations of the initial matrix representation, without completely inverting the latter,
wherein while said iterative calculation of the adapter follows a calculation rule where a current block (i, j) of the intermediate matrix is defined by the difference between the corresponding block (i, j) of the initial matrix representation and a sum of blocks, each defined by a product involving two already calculated blocks of the intermediate matrix, and an auxiliary block of an approach matrix which is forced to meet with an already calculated diagonal block of the intermediate matrix, an equivalence condition, comprising an expression of comparison of two matrix products both including said filtering matrix representation or its transposed and an already calculated block of the intermediate matrix, and respectively including the inverse of said already calculated diagonal block of the intermediate matrix, and said auxiliary block of the approach matrix.

2. The device according to claim 1, wherein the stability condition comprises a comparison of two matrix products, both being respectively the initial matrix representation, and the working matrix representation, and said filtering matrix representation and wherein the sum of blocks is achieved, for a non-zero index k and strictly less than the minimum between i and j, each block of the sum being defined by the matrix product of the PQR form,
wherein P is the block (i, k) of the intermediate matrix,
wherein Q is the auxiliary block (k, j) of the approach matrix of index, the equivalence condition comprising the comparison of two matrix products of respectively said auxiliary block (k, j) of the approach matrix and the inverse of the already calculated diagonal block (k, k) of the intermediate matrix, with the already calculated block (k, j) of the intermediate matrix representation and with the block j of said filtering matrix representation (t), and
wherein R is the block (k, j) of the intermediate matrix.

3. The device according to claim 1, wherein the stability condition comprises a comparison of two matrix products, both between the transposed of the filtering matrix representation and respectively the initial matrix representation, and the working matrix representation, and wherein the sum of blocks is achieved, for a non-zero index k and strictly less than the minimum between i and j, each block of the sum being defined by the matrix product of the PQR form,
wherein P is the block (i, k) of the intermediate matrix,
wherein Q is the auxiliary block (i, k) of the approach matrix, the equivalence condition comprising the comparison of two matrix products of the block i of said filtering matrix representation with the already calculated block (i, k) of the intermediate matrix representation, and with respectively said auxiliary block (i, k) of the approach matrix, and the inverse of the already calculated diagonal block (k, k) of the intermediate matrix, and
wherein R is the block (k, j) of the intermediate matrix.

4. The device according to claim 1, wherein the auxiliary block of the approach matrix is calculated from a term-to-term division involving the already calculated block of the intermediate matrix of index (k, k), and either the block j of said filtering matrix representation and the already calculated block (k, j) of the intermediate matrix or the block i of said filtering matrix representation and the already calculated block (i, k) of the intermediate matrix.

5. The device according to claim 1 wherein the approach matrix is calculated by a deflation method, wherein a first term either involves the block j of said filtering matrix representation and the already calculated block (k, j) of the intermediate matrix, or the block i of said filtering matrix representation and the already calculated block (i, k) of the intermediate matrix, wherein a second term involves the already calculated diagonal block (k, k) of the intermediate matrix and the first term, and a third term involves the first and second terms as well as the matrix of the initial matrix representation.

6. The device according to claim 1, wherein the filtering matrix representation is a column vector.

7. The device according to claim 1, wherein the adapter is re-ordering the initial matrix representation producing a modified matrix representation according to an ordering rule associating blocks of the matrix of the initial matrix representation as a function of a dependence condition, and for calculating the working matrix representation by replacing the initial matrix representation with the modified matrix representation.

8. The device according to claim 7, wherein the adapter calculating a graph from the modified matrix representation wherein for a given level, the calculations of the blocks of the intermediate matrix may be carried out in an independent way, and for calculating the blocks of a same level of the graph in parallel.

9. The device according to claim 1, further comprising a set of sensors, a digitizer, a discretize and a driver, wherein the driver calls the discretizer with data drawn from the digitizer which operates on the data drawn from the set of sensors, in order to produce the initial matrix representation and the data of residues, and controls the adapter and the calculator-solver accordingly.

10. The device according to claim 1, wherein the system of equations is representative of a complex physical system of the real world, such as an oil field.

11. A multipurpose calculation method comprising the steps of:
receiving an initial matrix representation corresponding to a system of equations to be processed and a filtering matrix representation,
calculating a working matrix representation meeting with the initial matrix representation, a condition of stability comprising an expression of the comparison of two matrix products both including said filtering matrix representation or its transposed, and respectively including the initial matrix representation, and the working matrix representation,
receiving data of residues, and solving the system of equations defined by the initial matrix representation, from data of residues, of the working matrix representation, and of the initial matrix representation,
wherein the calculating step comprises iterative blockwise calculation of an intermediate matrix from the initial matrix representation and from said numerical representation of a filtering matrix representation by iteratively repeating, for each current block (i, j) of the intermediate matrix:
calculating a sum of blocks each defined by a product involving two already calculated blocks of the intermediate matrix, and an auxiliary block of an approach matrix which is forced to meet with an already calculated diagonal block of the intermediate matrix, a condition of equivalence, comprising an expression of comparison of two matrix products both including said filtering matrix representation or its transposed and an already calculated block of the intermediate matrix, and respectively including the inverse of said already calculated diagonal block of the intermediate matrix, and said auxiliary block of the approach matrix,
calculating the difference between the block (i, j) of the matrix of the initial matrix representation and the sum from the operation of calculating the sum of blocks, and in that the operation comprises working on the intermediate matrix, blockwise, so as to provide a solution to the system of equations of the initial matrix representation, without completely inverting the latter.
